(19) United States
(12) Patent Application Publication
(10) Pub. No.: US 2015/0382155 A1
(43) Pub. Date: Dec. 31, 2015

(54) System and Method for Reporting Use of a Mobile Communication Device While Driving

(71) Applicant: Mobile Safety Assure, LLC, Miamisburg, OH (US)

(72) Inventors: Matthew S. Ulliman, Dayton, OH (US); Patrick J. Brophy, Mint Hill,, NC (US); Jordan Christman, Kettering, OH (US); Tyree Bailey, Mason, OH (US); Chad A. Westgerdes, Coldwater, OH (US)

(21) Appl. No.: 14/317,027

(22) Filed: Jun. 27, 2014

(51) Int. Cl. H04W 4/04; H04W 4/00; H04W 4/02

(52) U.S. Cl. CPC H04W 4/046; H04W 4/027; H04W 4/008

(57) ABSTRACT

A method for reporting use of a mobile device may include: (1) determining whether a wireless communication signal is received by a mobile device, (2) determining whether the mobile device is in a driver compartment of a vehicle, (3) determining whether the vehicle is moving, (4) determining whether the mobile device is in use, and (5) reporting the use of the mobile device when the mobile device is in the driver compartment and the vehicle is moving.

### FIELD

The present disclosure is generally related to mobile communication devices and, more particularly, to systems and methods for reporting use of a mobile communication device while driving a vehicle.

### BACKGROUND

Mobile communication devices, such as smart phones and tablets, are now an integral part of daily life. However, use of these devices behind the wheel of an automobile is very dangerous and, in many regions, illegal. Statistically, use of mobile devices while driving accounts for over one-quarter of all automobile accidents over the last decade.

Currently there is no widely used or adopted method to prevent drivers from using their mobile device while operating a moving automobile. Most prevention approaches to this problem have been awareness campaigns advising the general public of the dangers of talking and texting while driving. Despite knowing the statistics of car accidents and associated fatalities that occur each year from using mobile devices, people continue to use them while driving.

Accordingly, those skilled in the art continue with research and development efforts in the field of preventing use of a mobile communication device while driving a vehicle.

### SUMMARY

In one embodiment, the disclosed method may include: (1) determining whether a short-range wireless communication signal is received by a wireless communication device, (2) determining whether the wireless communication device is at a first position, (3) determining whether the wireless communication device is in motion, and (4) reporting use of the wireless communication device when the wireless communication device is at the first position and the wireless communication device is in motion.

In another embodiment, the disclosed method may include: (1) determining whether a wireless communication signal is received by a mobile device, (2) determining whether the mobile device is in an operator (e.g., driver) compartment of a vehicle, (3) determining whether the vehicle is moving, (4) determining whether the mobile device is in use, and (5) reporting the use of the mobile device when the mobile device is in the operator compartment and the vehicle is moving.

In yet another embodiment, the disclosed system may include a positioning device configured to transmit a wireless communication signal, and a mobile device in wireless communication with the positioning device via the wireless communication signal, the mobile device including a processing unit, and a non-transitory computer readable medium storing instructions, wherein executing the instructions by the processing unit causes the mobile device to: (1) determine whether the wireless communication signal is received by the mobile device, (2) determine whether the mobile device is at a first position or a second position, (3) determine whether the mobile device is moving, (4) determine whether the mobile device is in use, and (5) report the use of the mobile device when the mobile device is in the first position and the mobile device is moving.

Other embodiments of the disclosed systems and methods will become apparent from the following detailed description, the accompanying drawings and the appended claims.

### BRIEF DESCRIPTION OF THE DRAWINGS

FIG. 1 is a schematic block diagram of one embodiment of the disclosed system for reporting usage of a wireless communication device;

FIGS. 2 and 3 are a flow diagram of one embodiment of the disclosed method for reporting usage of a wireless communication device;

FIG. 4 is a flow diagram of one embodiment of the operation of determining whether the first wireless control device is at a first position represented in FIG. 2;

FIG. 5 is a schematic block diagram of one embodiment of the operating environment in which the disclosed system and method are implemented;

FIG. 6 is a schematic block diagram of one embodiment of the mobile phone represented in FIG. 5;

FIG. 7 is a schematic block diagram of one embodiment of the positioning device represented in FIG. 5;

FIGS. 8 and 9 are a flow diagram of one embodiment of the disclosed method for reporting use of the mobile phone in a moving vehicle;

FIG. 10 is a flow diagram of one embodiment of the operation of determining whether the mobile phone is in an operator compartment represented in FIG. 9; and

FIG. 11 is a flow diagram of one embodiment of the operation of reporting use represented in FIG. 9.

### DETAILED DESCRIPTION

The following detailed description refers to the accompanying drawings, which illustrate specific embodiments of the disclosure. Other embodiments having different structures and operations do not depart from the scope of the present disclosure. Like reference numerals may refer to the same element or component in the different drawings.

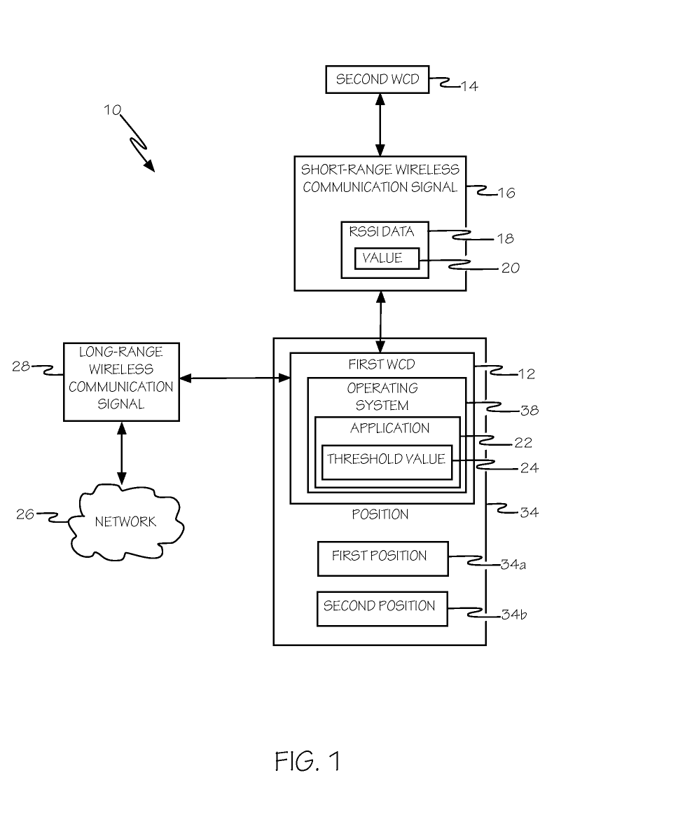

Referring to FIG. 1, disclosed is one embodiment of a system, generally designated 10, for reporting usage of a wireless communication device (“WCD”). The system 10 may include a first wireless communication device (“first WCD”) 12 and a second wireless communication device (“second WCD”) 14. The first WCD 12 and the second WCD 14 may be in wireless communication (e.g., via a radio frequency signal). The first WCD 12 and the second WCD 14 may be in wireless communication via a short-range wireless communication signal 16 (e.g., a short-range wireless communication protocol). The first WCD 12 may be in wireless communication with a network 26 via a long-range wireless communication signal 28 (e.g., a long-range wireless communication protocol).

Unless otherwise indicated, the terms “first,” “second,” etc. are used herein merely as labels, and are not intended to impose ordinal, positional, or hierarchical requirements on the items to which these terms refer.

As one example, the first WCD 12 may be configured to transmit and receive wireless signals over the long-range wireless communication signal 28 (e.g., communicate wirelessly with the network 26). As one example, the first WCD 12 may be configured to transmit and receive wireless signals over the short-range wireless communication signal 16 (e.g., communicate wirelessly with the second WCD 14). As one example, the second WCD 14 may be configured to transmit and receive wireless signals over the short-range wireless communication signal 16 (e.g., communicate wirelessly with the first WCD 12).

As one example, the network 26 may use digital radio transmissions to provide voice, data, and/or multimedia communication services and to wirelessly connect a plurality of devices and/or systems. For example, the network 26 may include, but is not limited to, a local area network (“LAN”), a wide area network (“WAN”), a metropolitan area network (“MAN”), a telephone network, a cellular network, a global area network (“GAN”) or a combination of networks.

As one example, the first WCD 12 may include any portable (e.g., mobile) computing and/or communication device (e.g., mobile device) with connectivity to the short-range wireless communication signal 16. As another example, the first WCD 12 may include any portable computing and/or communication device (e.g., mobile device) with connectivity to the long-range wireless communication signal 28. As yet another example, the first WCD 12 may include any portable computing and/or communication device with connectivity to both the short-range wireless communication signal 16 and the long-range wireless communication signal 28.

For example, the first WCD 12 may include, but is not limited to, a personal digital assistant (“PDA”), a mobile phone (e.g., a smart phone, such as an iPhone®, or a cellular phone), a tablet computer (e.g., a tablet, such as an iPad®) with connectivity to the short-range wireless communication signal 28 and/or the long-range wireless communication signal 28, a laptop computer with connectivity to the short-range wireless communication signal 28 and/or the long-range wireless communication signal 28, or similar device.

The first WCD 12 may include one or more applications 22 (also known as APPs). The application 22 may take the form of a computer program product embodied in one or more computer readable mediums having computer readable program code embodied thereon. As used herein, the term “computer-readable medium” may refer to any medium that participates in providing instructions to a processor for execution. Any combination of one or more computer readable mediums may be utilized. The first WCD 12 may include an operating system 38 capable of executing the application 22.

As one example, the computer readable medium may include a non-transitory computer readable storage medium. The non-transitory computer readable storage medium may include, but is not limited to, an electronic, magnetic, optical, electromagnetic, infrared, or semiconductor system, apparatus, or device, or any suitable combination thereof. As one example, the non-transitory computer readable storage medium may include at least one of: an electrical connection having one or more wires, a portable computer diskette, a hard disk, random access memory (“RAM”), read-only memory (“ROM”), programmable read-only memory (“PROM”), erasable programmable read-only memory (“EPROM” or Flash memory), an optical fiber, a digital optical storage device (e.g., a CD or DVD), a magnetic storage device, a memory chip or cartridge, or any suitable combination thereof. Those skilled in the art will recognize that the non-transitory computer readable storage medium may be any tangible medium that may contain or store a computer program (e.g., the application 22) for use by or in connection with an instruction execution system, such as a computing device (e.g., the first WCD 12).

The short-range wireless communication signal 16 may include received signal strength indicator (“RSSI”) data 18. The RSSI data 18 may include measurements of the power present in a wireless signal (e.g., a radio signal) received by the first WCD 12. As one example, the measurement of the power present in the wireless signal received by the first WCD 12 may be defined as a value 20 (e.g., a numerical value).

Those skilled in the art will recognize that the value 20 representing the power in the wireless signal may be inversely related to the distance from the source of the wireless signal to another location (e.g., the received location). As one example, the value 20 may be inversely related to the distance between two wireless communication devices (“WCDs”), for example, between a transmitting wireless communication device (e.g., the second WCD 14) and a receiving wireless communication device (e.g., the first WCD 12). As one example, as the distance between two WCDs increases, the value 20 may decrease. As one example, as the distance between two WCDs decreases, the value 20 may increase.

The application 22 (e.g., the APP) may include a predefined threshold value 24. As one example, the threshold value 24 may be defined by a particular value corresponding to a particular predefined distance (e.g., a maximum distance) between the first WCD 12 and the second WCD 14. As one example, the threshold value 24 may be defined by a range of values corresponding to a range of predefined distances between the first WCD 12 and the second WCD 14.

The application 22 may be configured to acquire the value 20 from the RSSI data 18 of the short-range wireless communication signal 16 at a current position 34 (e.g., location) of the first WCD 12 with respect to the second WCD 14 and compare the value 20 to the threshold value 24 in order to determine whether the first WCD 12 is at a first position 34a or a second position 34b. As one example, the first position 34a may be any position 34 (e.g., of the first WCD 12 with respect to the second WCD 14) where the value 20 is greater than the threshold value 24 (e.g., when the distance between the first WCD 12 and the second WCD 14 is less than the predefined distance). As another example, the first position 34a may be any position 34 where the value 20 is within the range of threshold values 24 (e.g., when the distance between the first WCD 12 and the second WCD 14 is between the range of predefined distances). As one example, the second position 34b may be any position 34 where the value 20 is less than the threshold value 24 (e.g., when the distance between the first WCD 12 and the second WCD 14 is greater than the predefined distance). As another example, the second position 34b may be any position 34 where the value 20 is not within the range of threshold values 24 (e.g., when the distance between the first WCD 12 and the second WCD 14 is not between the range of predefined distances).

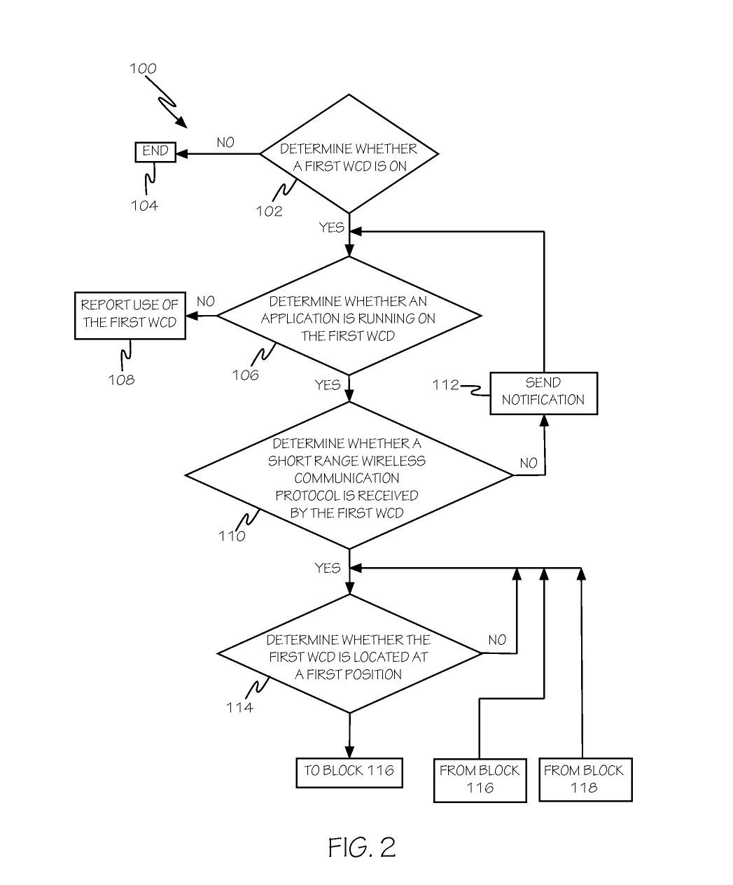

Referring to FIG. 2, disclosed is one embodiment of a method, generally designated 100, for reporting usage of the wireless communication device (“WCD”). The method 100 may include a series of operational steps (e.g., instructions) implemented by the application 22 (e.g., the APP) and executed by the first WCD 12 (e.g., a mobile phone or tablet).

Referring to FIG. 2, and with reference to FIG. 1, the method 100 may begin at block 102 by determining whether the first WCD 12 is powered ON. If a determination is made that the first WCD 12 is powered OFF, then the operation may end (e.g., terminate), as shown at block 104. If a determination is made that the first WCD 12 is powered ON, then whether the application 22 is running on the first WCD 12 may be determined, as shown at block 106. The application 22 may be configured to be in an always ON condition. As one example, the application 22 may be configured to initiate upon powering ON the first WCD 12. As one example, the application 22 may be configured to operate in the background of the operating system 38 of the first WCD 12 following initiation of the application 22.

If a determination is made that the application 22 is not running, then use of the first WCD 12 without the application 22 running may be reported, as shown at block 108. As one example, the reporting operation (block 108) may be performed (e.g., executed) upon a first initiation of the application 22 following a last use of first WCD 12 without the application 22 running. If a determination is made that the application 22 is running, then whether the short-range wireless communication signal 16 is being received by the first WCD 12 may be determined, as shown at block 110.

If a determination is made that the short-range wireless communication signal 16 is not being received (e.g., a short-range wireless communication transceiver is not enabled), then a notification may be sent, as shown at block 112, and the method 100 may continue at block 106. In one example implementation, the notification may be sent to a user of the first WCD 12. As one example, the notification may include instructions to enable reception and/or transmission of the short-range wireless communication signal 16 (e.g., “Turn ON Bluetooth”). As another example, the notification may include an alarm, such as an audible alarm, a visual alarm (e.g., a banner), and/or a tactile alarm (e.g., a vibration). If a determination is made that the short-range wireless communication signal 16 is being received (e.g., a short-range wireless communication transceiver is enabled), then whether the first WCD 12 is at the first position 34a may be determined, as shown at block 114.

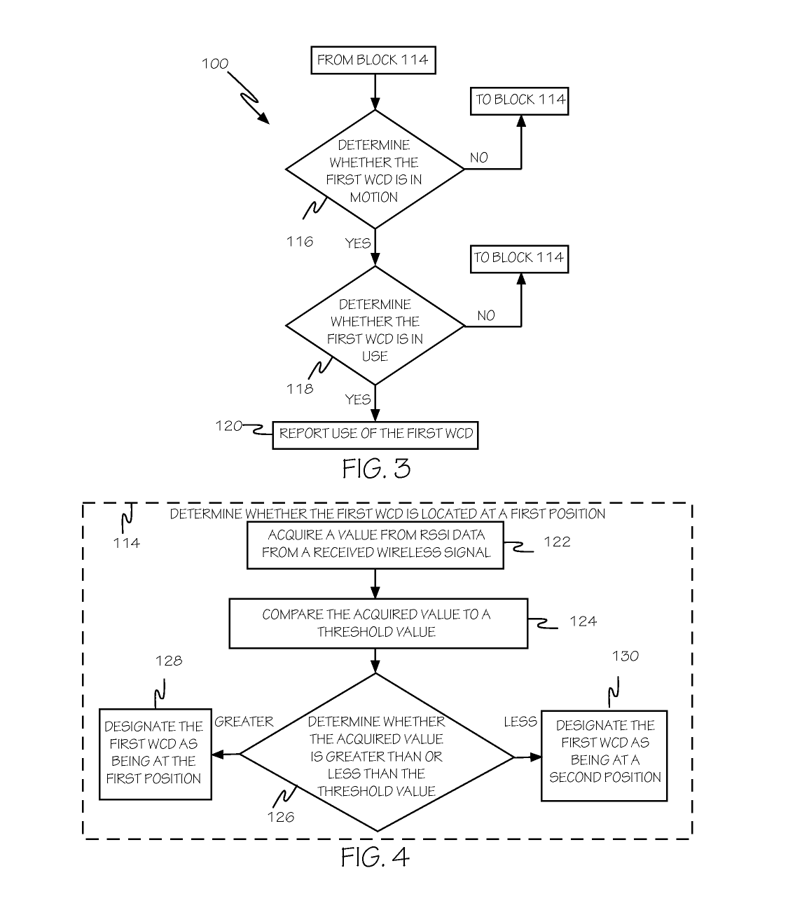

Referring to FIG. 4, and with reference to FIG. 1, in one example implementation, determining whether the first WCD 12 is at the first position 34a may include acquiring the value 20 from the RSSI data 18 of a received wireless signal (e.g., the wireless signal received from the second WCD 14), as shown at block 122. The acquired value 20 may then be compared to the threshold value 24, as shown at block 124. Whether the acquired value 20 is greater than or less than the threshold value 24 (or whether the acquired value 20 is within the range of threshold values 24) may then be determined, as shown at block 126, based on the comparison between the acquired value 20 and the threshold value 24. If the acquired value 20 is greater than the threshold value 24 (or the acquired value 20 is within the range of threshold values 24), then the first WCD 12 may be designated as being at the first position 34a, as shown at block 128. If the acquired value 20 is less than the threshold value 24 (or the acquired value 20 is not within the range of threshold values 24), then the first WCD 12 may be designated as being at the second position 34b, as shown at block 130.

Referring to FIG. 2, and with reference to FIG. 1, if a determination is made that the first WCD 12 is not at the first position 34a (e.g., is at the second position 34b), then the method 100 may continue at block 114. The operational step shown at block 114 may be repeated until a determination is made that the first WCD 12 is at the first position 34a. If a determination is made that the first WCD 12 is at the first position 34a, then whether the first WCD 12 is in motion may be determined, as shown at block 116 (FIG. 3).

As one example, and as will be further described herein below, the first WCD 12 may include one or more components configured to indicate whether the first WCD 12 is moving or is at rest.

Referring to FIG. 3, and with reference to FIG. 1, if a determination is made that the first WCD 12 is not in motion, then the method 100 may continue at block 114 (FIG. 2). The operational steps shown at blocks 114 and 116 may be repeated until a determination is made that the first WCD 12 is at the first position 34a and that the first WCD 12 is in motion. If a determination is made that the first WCD 12 is in motion, then whether the first WCD 12 is in use may be determined, as shown at block 118.

If a determination is made that the first WCD 12 is not in use, then the method 100 may continue at block 114 (FIG. 2). The operational steps shown at blocks 114, 116, and 118 may be repeated until a determination is made that the first WCD 12 is at the first position 34a, that the first WCD 12 is in motion, and that the first WCD 12 is in use. If a determination is made that the first WCD 12 is at the first position 34a (block 114), that the first WCD 12 is in motion (block 116), and that the first WCD 12 is in use (block 118), then use of the first WCD 12 may be reported, as shown at block 120.

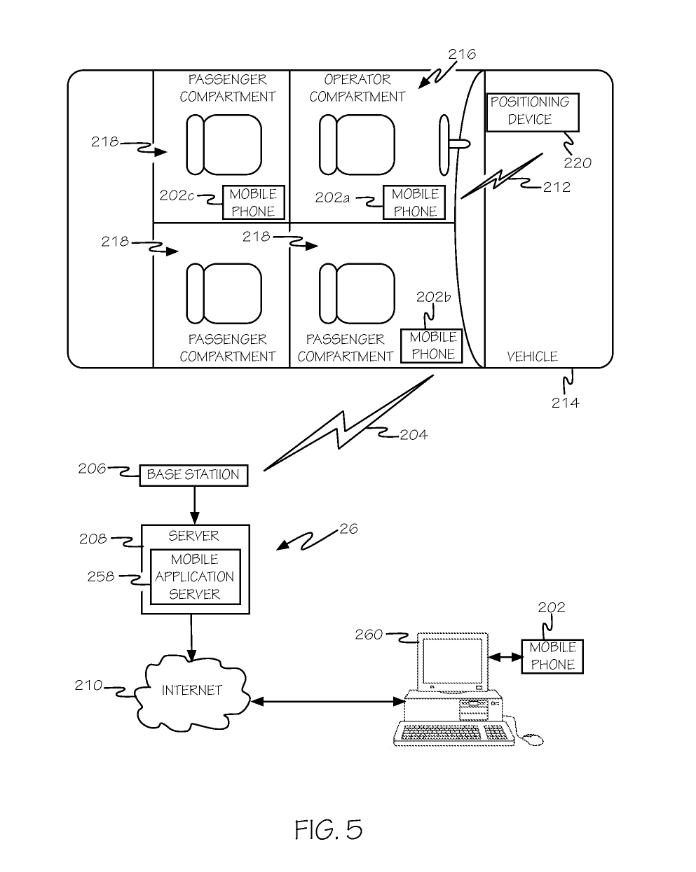

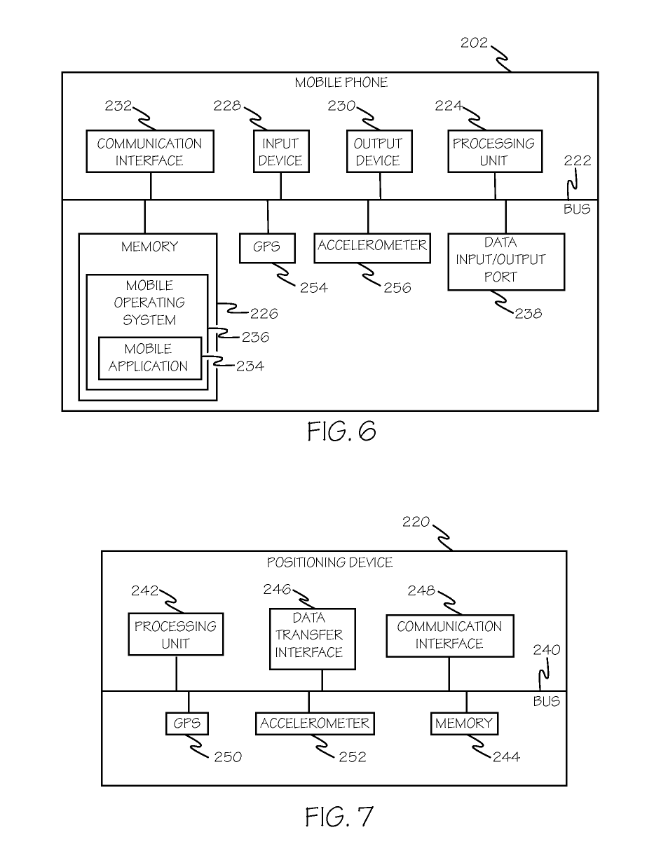

Referring to FIG. 5, one embodiment of an operating environment, generally designated 200, in which the disclosed system 10 and method 100 may be implemented may include one or more mobile phones 202 (individually designated 202a, 202b, and 202c), a positioning device 220, and a vehicle 214. Accordingly, and by example, the mobile phone 202 may be the first WCD 12 (FIG. 1), a mobile application 234 (FIG. 6) may be the application 22 (FIG. 1), and the positioning device 220 may be the second WCD 14 (FIG. 1). The positioning device 220 may be in wireless communication with one or more of the mobile phones 202 (e.g., mobile phones 202a, 202b, and/or 202c).

Those skilled in the art will recognize that the mobile phone 202 is only one example first WCD 12 (e.g., mobile device) and that various other types of mobile computing and/or communication devices (e.g., tablets) may be the first WCD 12, without limitation.

The vehicle 12 may include any mobile machine operated by an operator (e.g., a driver, pilot, or the like) and/or that transports passengers and/or cargo. For example, the vehicle 12 may include any land vehicle (e.g., an automobile or train), marine vehicle (e.g., a boat), air vehicle (e.g., an aircraft), or the like.

The network 26 (FIG. 1) may include one or more base stations 206 (only one base station 206 is shown by example in FIG. 5), one or more servers 208 (only one server 208 is shown by example in FIG. 5), and the Internet 210. The base station 206 may be in communication with the servers 208 (e.g., a central processor) and/or with the Internet 210. For example, the base station 206 may be in wireless communication or wired communication with the servers 208 and/or the Internet 210. The base station 206 may facilitate wireless communication (e.g., data traffic, voice traffic, control traffic, etc.) between servers 208 and/or the Internet 210 and the mobile phone 202. The base station 206 may include an antenna to transmit and receive signals to and from the mobile phone 202 or other mobile computing and/or communication device (e.g., mobile device). The server 208 may include one or more computers for hosting programs and/or databases and/or communicating with the Internet 210. As one example, the server 208 may include one or more mobile application servers 258.

Those skilled in the art will recognize that the network 26 may include more or fewer components or a different configuration of components than illustrated in FIG. 5. As one example, the network 26 may include one or more mobile switching centers (not shown), one or more databases (not shown), and/or one or more central processors (not shown).

The long-range wireless communication signal 28 (FIG. 1) may include any mobile communication signal 204 using a mobile communication standard or air (e.g., mobile communication) interface protocol (e.g., a cellular data communication protocol) that allows for the exchange of data over long distances and wireless communication between the mobile phone 202 and the base station 206 (e.g., over the network 26). For example, the mobile communication standard 204 may include, but is not limited to, EDGE, 1G, 3G, LTE, 4G, 5G, and the like.

The short-range wireless communication signal 16 (FIG. 1) may include any wireless communication signal 212 using a wireless communication standard or air (e.g., wireless communication) interface protocol that allows for the exchange of data over short distances and wireless communication between two or more mobile phones 202 (e.g., over a personal area network (“PAN”)). For example, the wireless communication standard 212 may include Bluetooth, Bluetooth low energy (e.g., Bluetooth Smart), and the like.

Referring to FIG. 6, one embodiment of the mobile phone 202 (e.g., the first WCD 12) or other mobile computing and/or communication device may include a bus 222, a processing unit 224, a memory 226, an input device 228, an output device 230, a communication interface 232, and a data input/output port 238.

The bus 222 may permit communication among the components of the mobile phone 202 or other mobile computing and/or communication device. The processing unit 224 may include one or more processors or microprocessors that interpret and execute instructions. The memory 226 may include a random access memory (“RAM”) or another type of dynamic storage device that stores information and instructions for execution by the processing unit 224, a read-only memory (“ROM”) or another type of static storage device that stores static information and instructions for the processing unit 224, and/or some other type of magnetic or optical recording medium and its corresponding drive for storing information and/or instructions. The memory 226 may include space within a single physical memory device or spread across multiple physical memory devices.

The input device 228 may include any device that permits a user to input information to the mobile phone 202 including, but not limited to, a keyboard, a keypad, a mouse, a pen, a microphone, a touchscreen display, one or more biometric mechanisms, and the like. The output device 230 may include any device that outputs information to the user including, but not limited to, a display, a speaker, and the like.

Those skilled in the art will recognize that information may include, but is not limited to, voice data, text messages (e.g., SMS and MMS), photographic images, numbers, names, addresses, geographic location coordinates, operational icons, operational words, graphic images, status images, status messages, data inputs, data outputs, or combinations thereof.

The communication interface 232 may include any transceiver-like mechanism that enables the mobile phone 202 or other mobile computing and/or communication device to communicate with other devices and/or systems. As one example, the communication interface 232 may include mechanisms for communicating over long distances with the base station 206 and/or with other mobile phones 202 (e.g., over the mobile communication standard 204). As one example, the communication interface 232 may include mechanisms for communicating over short distances with other mobile phones 202 and/or with the positioning device 220 (e.g., over the wireless communication standard 212). As one specific, non-limiting example, the communication interface 232 may include antennas (e.g., a cellular antenna and/or a Bluetooth antenna) and other circuitry (e.g., an RF module, a Bluetooth module, a Bluetooth low energy module, etc.) associated with wireless communication.

The mobile phone 202 may also include additional components (not shown) including, but not limited to, a power supply (e.g., a battery), an electronic circuit board, at least one function button, an audio output jack, a charging port, a photographic lens, etc.

The mobile phone 202 may perform certain operations in response to the processing unit 224 executing software instructions contained in the computer-readable medium, such as the memory 226. The software instructions may be read into the memory 226 from another computer-readable medium or from another device via the communication interface 232 and/or the data input/output port 238. The software instructions contained in the memory 226 may cause the processing unit 224 to perform some or all of the operations described herein below. Alternatively, or additionally, hardwired circuitry may be used in place of or in combination with the software instructions to implement the operations described herein below. Thus, implementations described herein are not limited to any specific combination of hardware circuitry and software.

As one example, the mobile application 234, also known as a mobile APP, may include a software application (e.g., instruction) designed to run on a mobile operating system 236 of the mobile phone 202. As one example, the mobile application 234 (e.g., mobile APP) may take the form of a computer program product (e.g., software instructions) embodied in one or more computer readable mediums having computer readable program code embodied thereon. The mobile application 234 may be available through various application distribution platforms, which may be operated by the owner of the mobile operating system 236 (e.g., Apple, Android, Microsoft, etc.), a telecommunication carrier, a device manufacturer, or a business enterprise. A user may download the mobile application 234 to the mobile phone 202 with a compatible mobile operating system 236 capable of executing the mobile application 234 on behalf of the user.

Although FIG. 6 depicts example components of one embodiment of the mobile phone 202, in other embodiments, the mobile phone 202 may include fewer components, additional components, different components, or differently arranged components. Additionally, although the first WCD 12 (FIG. 1) is depicted as a mobile phone 202, those skilled in the art will recognize that in other embodiments and/or implementations the first WCD 12 may be another type of mobile computing and/or communication device including substantially similar components as those depicted for the mobile phone 202.

In one embodiment, the mobile phone 202 (or other mobile computing and/or communication device) and/or the mobile application 234 may identify a particular user. As one example, the mobile phone 202 may identify the user (e.g., the operator of the vehicle 214) by recording and/or reporting the telephone number associated with the mobile phone 202 owned by the user. As another example, the mobile application 234 may identify the user (e.g., the operator of the vehicle 214) by recording and/or reporting a username and/or profile associated with registration of the mobile application 234.

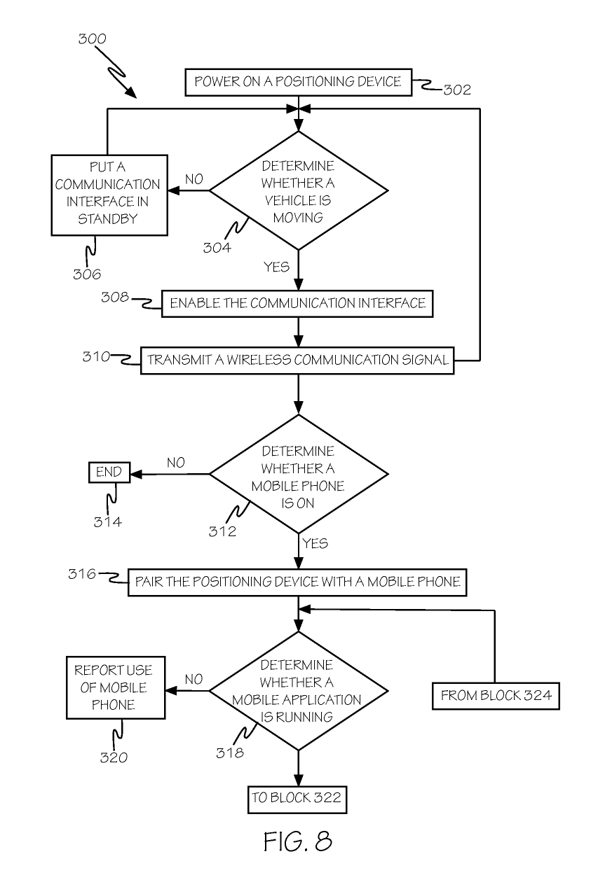

Referring to FIG. 7, one embodiment of the positioning device 220 (e.g., the second WCD 14) may include a bus 240, a processing unit 242, a memory 244, a data transfer interface 246, and a communication interface 248.

The bus 240 may permit communication among the components of the positioning device 220. The processing unit 242 may include one or more processors or microprocessors that interpret and execute instructions. The memory 244 may include a random access memory (“RAM”) or another type of dynamic storage device that stores information and instructions for execution by the processing unit 242 or a read-only memory (“ROM”) or another type of static storage device that stores static information and instructions for the processing unit 242.

The data transfer interface 246 may include any data transfer mechanism that allows the positioning device 220 to exchange and/or transfer data with an external computing device (e.g., a computer). As one example, the data transfer interface 246 may include a data input/output port (e.g., USB, mini-USB, micro-USB, etc.) that may be communicatively connected to the external computing device.

The communication interface 248 may include any transceiver-like mechanism that enables the positioning device 220 to communicate with other devices and/or systems. As one example, the communication interface 248 may include mechanisms for communicating over short distances with mobile phones 202 (e.g., over the wireless communication standard 212). As one specific, non-limiting example, the communication interface 248 may include antennas (e.g., a Bluetooth antenna) and other circuitry (e.g., a Bluetooth module or Bluetooth low energy module) associated with wireless communication.

The positioning device 220 may also include additional components (not shown) including, but not limited to, a power supply (e.g., a battery or a power connection), an electronic circuit board, at least one function button, a charging port, etc.

The positioning device 220 may perform certain operations in response to the processing unit 242 executing software instructions contained in the computer-readable medium, such as the memory 244. The software instructions may be read into the memory 244 from another computer-readable medium or from another device via the data transfer interface 246. The software instructions contained in the memory 244 may cause the processing unit 224 to perform some or all of the operations described herein below. Alternatively, or additionally, hardwired circuitry may be used in place of or in combination with the software instructions to implement the operations described herein below. Thus, implementations described herein are not limited to any specific combination of hardware circuitry and software.

Referring to FIG. 5, one example of the vehicle 214 may include any automobile operated by an operator (e.g., a driver). As one example, the vehicle 214 may carry passengers other than the operator. In the example operating environment 200 of FIG. 5, a cabin of vehicle 214 includes an operator compartment 216 (e.g., a driver compartment) as well as three passenger compartments 218. As used herein, the term “operator compartment” (e.g., driver compartment) may include a volume around the operator (e.g., driver, pilot, or the like) of vehicle 214 in which the operator may interact with the mobile phone 202a. As used herein, the term “passenger compartment” may include a volume around a passenger of vehicle 214 in which the passenger may interact with the mobile phone 202b, 202c.

As one example, and as shown in FIG. 5, the mobile phone 202a may be within reach of the operator of the vehicle 214 while driving. Therefore, the mobile phone 202a would be considered in the operator compartment 216. The mobile phones 202b, 202c may be within reach of the passengers of the vehicle 214 but not be within reach of the operator of the vehicle 214. Therefore, the mobile phones 202b, 202c would not be considered in the operator compartment 216 and would be considered in the passenger compartment 218 because the mobile phones 202b, 202c would not be within reach of the operator while driving the vehicle 214.

As described above, the wireless communication signal 212 may include the RSSI data 18 (FIG. 1). The measurement of the power present in the wireless communication signal 212 received by the mobile phone 202 or other mobile computing and/or communication device (e.g., transmitted by the positioning device 220) may be defined as the value 20 (FIG. 1). The mobile application 234 (FIG. 6) may include the predefined threshold value 24. The mobile application 234 (e.g., mobile APP) may be configured to acquire the value 20 from the RSSI data 18 of the wireless communication signal 212 at a current position 34 (e.g., location) of the mobile phone 202 with respect to the positioning device 220 and compare the value 20 to the threshold value 24 in order to determine whether the mobile phone 202 is in the driver compartment 216 of the passenger compartment 218.

The positioning device 220 may be located at a predefined location on the vehicle 214 relative to the operator compartment 216. As one example, the positioning device 220 may be located in the cabin of the vehicle 214 proximate (e.g., at or near) the operator compartment (e.g., on or beneath a dashboard, behind a knee bolster, beneath a driver seat, in a driver side door, etc.). As one example implementation, the positioning device 220 may take the form of a stand-alone device. As another example implementation, the positioning device 220 may be integrated into the vehicle systems by a vehicle manufacturer or aftermarket installer. As yet another example implementation, the positioning device 220 may be a wirelessly enabled communication system of the vehicle 214, such as a Bluetooth sync system.

As one example, the threshold value 24 may be defined by a particular value corresponding to the distance from the positioning device 220 to a limit of the operator compartment 216. Therefore, when the mobile phone 202 is in the operator compartment 216 (e.g., as illustrated by mobile phone 202a in FIG. 5), the value 20 may be greater than the threshold value 24 and the mobile application 234 may designate the mobile phone 202 as being in the operator compartment 216. Similarly, when the mobile phone 202 is in the passenger compartment 218 (e.g., as illustrated by mobile phones 202b, 202c in FIG. 5), the value 20 may be less than the threshold value 24 and the mobile application 234 may designate the mobile phone 202 as being in the passenger compartment 218 (e.g., not being in the operator compartment 216).

Those skilled in the art will recognize that the distance from the positioning device 220 to the limit of the operator compartment 216 and, thus, the threshold value 24 may depend on the type of vehicle 214 and/or the size of the cabin of the vehicle 214 (e.g., the size of the operator compartment 216 and/or the passenger compartment 218). In one example implementation, the mobile application 234 may allow for the user to select between varieties of vehicle types in order to define the threshold value 24. As one example, the user may select a type of vehicle, such as an automobile, a boat, an aircraft, and the like. As another example, the user may select a class of vehicle, such as a mini-compact, a sub-compact, a compact, a midsize, or a full size car; a small, standard, or large pickup truck; a small, standard, or large SUV or van; a commercial vehicle (e.g., a semi-trailer truck); a boat size (e.g., class A, class 1, class 2, class 3, etc. boat); or an aircraft size. As yet another example, the user may select a year, make, and model of the vehicle (e.g., a 2014 Honda Accord).

The mobile application 234 may generate the threshold value 24 based on such a vehicle selection. In one example implementation, the mobile application 234 may generate the threshold value 24 by selecting the threshold value 24 corresponding to the selected vehicle from a database or index including a plurality of vehicles or vehicle types and corresponding threshold values 24. As one example, the database or index may be included in the mobile application 234 (e.g., stored in the memory 226 of the mobile phone 202). As another example, the database or index may be stored on the mobile application server 258 and the mobile application 234 may retrieve the threshold value 24 from the mobile application server 258 (e.g., by communicating with the mobile application server 258 over the network 26).

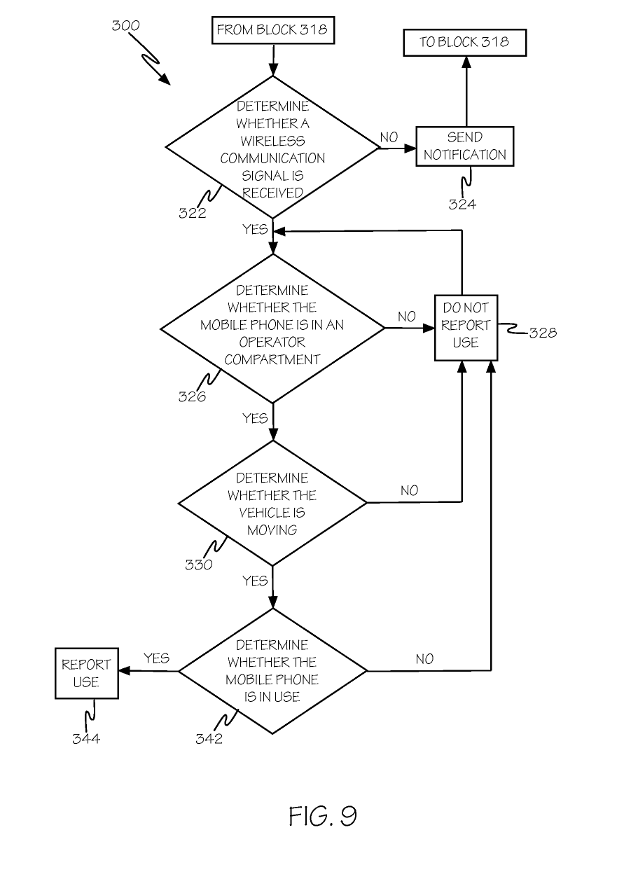

Referring to FIG. 8, disclosed is one embodiment of a method, generally designated 300, for reporting use of a mobile phone in a moving vehicle. The method 300 may include a series of operational steps (e.g., instructions) implemented by the mobile application 234 (e.g., the mobile APP) and executed by the mobile phone 202 and a series of operational steps executed by the positioning device 220. Generally, the method 300 may determine whether the mobile phone 202 or other mobile computing and/or communication device is being used by the operator of the vehicle 214 when the vehicle 214 is moving and report such usage of the mobile phone 202 in order to reduce unsafe driving conditions.

Referring to FIGS. 8 and 9, and with reference to FIGS. 5-7, the method 300 may begin at block 302 by powering ON the positioning device 220. As one example, the operator of the vehicle 214 may manually power ON the positioning device 220. As another example, the positioning device 220 may be electrically coupled to the vehicle 214 and automatically power ON upon ignition of the vehicle 214.

As shown at block 304, the positioning device 220 may determine whether the vehicle 214 is moving. In one example embodiment, the positioning device 220 may include at least one of a Global Positioning System module (“GPS”) 250 and/or an accelerometer 252. As one example, the GPS 250 may detect movement of the vehicle 214 (e.g., driving an automobile, piloting an aircraft or boat, etc.) in response to a measured position change of the positioning device 220. As one example, the accelerometer 252 may detect movement of the vehicle 214 in response to a measured acceleration of the positioning device 220. Upon a measured movement of the vehicle 214, the GPS 250 and/or the accelerometer 252 may transmit an initiation signal to the processing unit 242 to begin transmitting the wireless communication signal 212.

If a determination if made that the vehicle 214 is not moving, then the method 300 may continue at block 304. As one example, if a determination if made that the vehicle 214 is not moving, then the positioning device 220 (e.g., the processing unit 242) may put the communication interface 248 (e.g., the Bluetooth module) in a standby condition (e.g., standby mode), as shown at block 306. Accordingly, when the vehicle 214 is not moving, use the mobile phone 202 by the operator of the vehicle 214 may not create an unsafe operating (e.g., driving) condition. The operational steps shown at blocks 304 and 306 may be repeated until a determination is made that the vehicle 214 is moving.

If a determination is made that the vehicle 214 is moving, then the positioning device 220 may enable the communication interface 248, as shown at block 308. As one example, if a determination is made that the vehicle 214 is moving, then the positioning device 220 may put the communication interface 248 (e.g., the Bluetooth module) in a discoverable condition (e.g., mode) and transmit the wireless communication signal 212 (e.g., Bluetooth low energy signal), as shown at block 310.

The operations shown at blocks 304, 308, and 310 may be performed iteratively to continually determine whether the vehicle 214 is moving. If at any point the vehicle 214 stops moving, the positioning device 220 may cease (e.g., temporarily cease) transmission of the wireless communication signal 212 until the vehicle 214 is moving again (e.g., the communication interface 248 may be put in the standby condition (block 306)). As one example, the positioning device 220 may intermittently perform a check to determine whether the vehicle 214 is moving. As another example, the positioning device 220 may constantly monitor whether the vehicle 214 is moving.

The method 300 may continue by determining (e.g., by the mobile application 234) whether the mobile phone 202 is powered ON, as shown at block 312. If a determination is made that the mobile phone 202 is powered OFF, then the operation may end (e.g., terminate), as shown at block 314. Accordingly, when the mobile phone 202 is powered OFF, use the mobile phone 202 may not be possible and an unsafe operating condition may not be created.

When a determination is made that the vehicle 214 is moving (block 304) and the mobile phone 202 is powered ON (block 312), the mobile phone 202 may detect the positioning device 220 (e.g., communicate with the positioning device 220 over the wireless communication signal 212) and pair (e.g., automatically or manually) with the positioning device 220, as shown at block 316.

If a determination is made that the mobile phone is powered ON, then whether the mobile application 234 is running on the mobile operating system 236 of the mobile phone 202 may be determined, as shown at block 318. The mobile application 234 may be configured to be in an always ON condition. As one example, the mobile application 234 may be configured to initiate upon powering ON the mobile phone 202 (e.g., the mobile application 234 may be started automatically by the mobile operating system 236. As one example, the mobile application 236 may be configured to operate in the background of the mobile operating system 236 of the mobile phone 202 following initiation of the mobile application 234. However, the operator of the vehicle 214 may, either intentionally or unintentionally, disable (e.g., close) the mobile application 234 or the mobile application 234 may crash and shut down.

If a determination is made that the mobile application 234 is not running, then use of the mobile phone 202 may be reported, as shown at block 320. In one example implementation, the reporting operation (block 320) may be performed (e.g., executed) upon a first initiation of the mobile application 234 following a last use of mobile phone 202 without the mobile application 234 running.

As one example, the mobile application 234 may communicate with one or more components of the mobile phone 202 to check a use history of the mobile phone 202 and determine if usage has occurred during a time period when the mobile application 234 was not running.

As another example, the mobile application 234 may determine if the location of the mobile phone 202 has changed (e.g., from a GPS position history) and, thus, that the vehicle 214 moved, during the time period when the mobile application 234 was not running.

As yet another example, the mobile application 234 may check a call and/or text history to determine if the mobile phone 202 had been used during the time period when the mobile application 234 was not running.

The report of use during the time period when the mobile application 234 was not running may be of interest to a third party, such as a monitoring user (e.g., a parent or an employer of the operator of the vehicle 214).

In one example implementation, the reporting operation (block 320) may include recording the use of the mobile phone 202 during the time period when the mobile application 234 was not running.

As one example, the record of use may be stored on the mobile phone 202 (e.g., in the memory 226) and retrieved (e.g., downloaded) from the mobile phone 202 by connecting the mobile phone 202 to a computer 260 (e.g., via the data input/output port 238).

As another example, the mobile application 234 may transmit the record of use to the mobile application server 258 over the network 26. The record may be stored on the mobile application server 258 for retrieval at a later time. The record may be accessed on the mobile application server 258 by the computer 260 (e.g., via the Internet 210) and/or another mobile computing and/or communication device.

As yet another example, the mobile application 234 may transmit the record of use directly to another device (e.g., another mobile phone 202 or computer 260) over the network 26.

If a determination is made that the mobile application 234 is running, then whether the wireless communication signal 212 is being received by the mobile phone 202, as shown at block 322 (FIG. 9). In one example implementation, the mobile application 234 may determine whether the communication interface 232 of the mobile phone 202 is enabled and whether the communication interface 232 is receiving the wireless communication signal 212. As one example, the mobile application 234 may determine whether the communication interface 232 (e.g., the Bluetooth module) of the mobile phone 202 is enabled and in communication with the communication interface 248 of the positioning device 220.

If a determination is made that the communication interface 232 of the mobile phone 202 is not enabled, then a notification may be sent, as shown at block 324, and the method 300 may continue at block 318. In one example implementation, the notification may be sent to a user of the mobile phone 202 (e.g., the driver). As one example, the notification may take the form of an alarm and/or alert. For example, the alarm and/or alert may include an audible sound transmitted by the mobile phone 202, a visual display (e.g., banner) displayed by the mobile phone 202, or a vibration of the mobile phone 202. As another example, the notification may include instructions to enable the communication interface 232 (e.g., Bluetooth) of the mobile phone 202 (e.g., “Turn ON Bluetooth”). In another example implementation, the notification may be sent to another mobile phone 202 or computer 260, for example, that of the monitoring user.

If a determination is made that the communication interface 232 is enabled, then whether the mobile phone 202 is in the operator compartment 216 may be determined, as shown at block 326.

If a determination is made that the mobile phone 202 is not in the operator compartment 216 (e.g., is in the passenger compartment), then use of the mobile phone 202 may not be reported, as shown at block 328, and the method 300 may continue at block 326. Accordingly, when the mobile phone 202 is not in the operator compartment 216, the operator of the vehicle 214 may not have access to the mobile phone 202 and an unsafe operating condition may not be created. The operational steps shown at block 326 may be repeated until a determination is made that the mobile phone 202 is in the operator compartment 216.

If a determination is made that the mobile phone 202 is in the operator compartment 216, then whether the vehicle 214 is in motion may be determined, as shown at block 330.

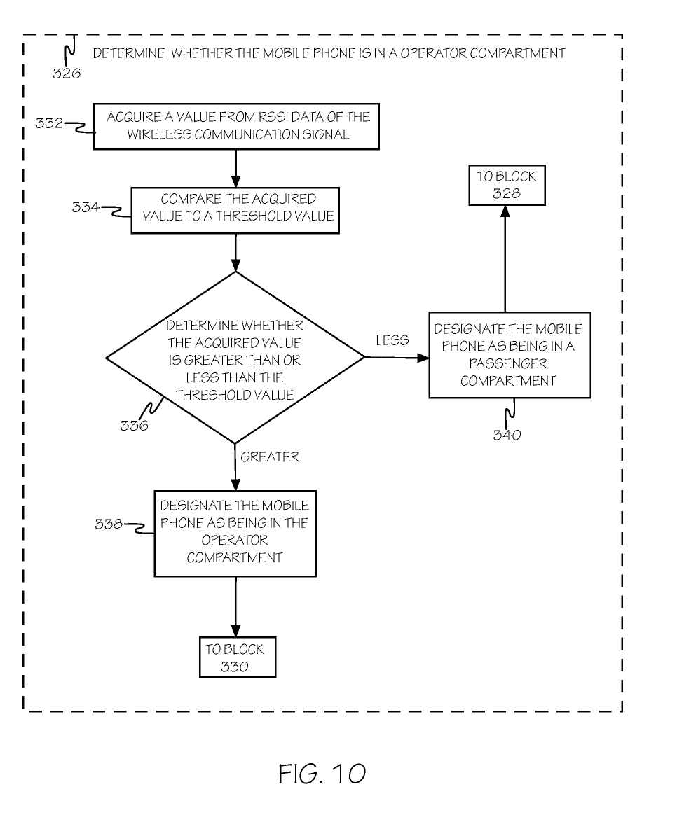

Referring to FIG. 10, and with reference to FIGS. 5-7, in one example implementation, determining whether the mobile phone 202 is in the operator compartment 216 (block 326) may include acquiring the value 20 from the RSSI data 18 of the wireless communication signal 212 received from the positioning device 220, as shown at block 332. The acquired value 20 may then be compared to the threshold value 24, as shown at block 334. Whether the acquired value 20 is greater than or less than the threshold value 24 (or whether the acquired value 20 is within the range of threshold values 24) may then be determined, as shown at block 336, based on the comparison between the acquired value 20 and the threshold value 24 (block 334).

If the acquired value 20 is greater than the threshold value 24 (or the acquired value 20 is within the range of threshold values 24), then the mobile phone 202 may be designated as being in the operator compartment 216 (e.g., is mobile phone 202a in FIG. 5), as shown at block 338. Once the mobile phone 202 has been designated as being in the operator compartment 216, the method 300 may continue at block 330.

If the acquired value 20 is less than the threshold value 24 (or the acquired value 20 is not within the range of threshold values 24), then the mobile phone 202 may be designated as being in the passenger compartment 218 (e.g., is mobile phone 202b or 202c in FIG. 5), as shown at block 340. Once the mobile phone 202 has been designated as being in the passenger compartment 218, the method may continue at block 328.

Referring to FIG. 9, and with reference to FIGS. 5-7, as shown at block 330, the mobile application 234 may determine whether the vehicle 214 is moving. In one example embodiment, the mobile phone 202 may include at least one of a Global Positioning System module (“GPS”) 254 and/or an accelerometer 256. As one example, the GPS 254 may detect movement of the vehicle 214 (e.g., driving) in response to a measured position change of the mobile phone 202. As another example, the accelerometer 256 may detect movement of the vehicle 214 in response to a measured acceleration of the mobile phone 202. Upon a measured movement of the vehicle 214, the GPS 254 and/or the accelerometer 256 may transmit a signal to the mobile application 234 indicating that the vehicle 214 is moving.

The determination whether the vehicle 214 is moving made by the mobile phone 202 may be in addition to or in place of the determination whether the vehicle 214 is moving made by the positioning device 220. In one example implementation, the positioning device 220 may be configured to begin transmitting the wireless communication signal 212 (e.g., the Bluetooth low energy signal) upon ignition of the vehicle 214 instead of upon a determination that the vehicle 214 is moving. In another example implementation, the positioning device 220 may be configured to begin transmitting the wireless communication signal 212 upon movement of the vehicle 214 as described herein above. In either implementation, as one example, if the mobile application 234 determines the vehicle 214 is moving but the mobile phone 202 is not paired with the positioning device 220 (e.g., is not receiving the wireless communication signal 212), the mobile application 234 may send a notification (e.g., an alert) to the operator (e.g., driver) and/or the monitoring user. The notification may alert the operator that there is a problem with the wireless communication between the mobile phone 202 and the positioning device 220.

If a determination if made that the vehicle 214 is not moving, then use of the mobile phone 202 may not be reported (block 328) and the method 300 may continue at block 326. Accordingly, when the mobile phone 202 is in the operator compartment 216 but the vehicle 214 is not moving, use the mobile phone 202 by the operator of the vehicle 214 may not create an unsafe operating condition. The operational steps shown at blocks 326 and 330 may be repeated until a determination is made that the mobile phone 202 is in the operator compartment 216 and the vehicle 214 is moving.

If a determination if made that the vehicle 214 is moving, then whether the mobile phone 202 is in use may be determined, as shown at block 342. In one example implementation, the mobile application 234 may communicate with various components and/or applications of the mobile phone 202 to determine whether the mobile phone 202 is in use while the mobile phone 202 is in the driver compartment 216 and the vehicle 214 is moving.

As one example, the mobile application 234 may communicate with the communication interface 232 to determine whether the mobile phone 202 is transmitting or receiving the mobile communication signal 202 (e.g., is communicating with the network 26) while the mobile phone 202 is in the operator compartment 216 and the vehicle 214 is moving.

As another example, the mobile application 234 may communicate with the accelerometer 256 of the mobile phone 202 to determine if the mobile phone 202 is being handled (e.g., picked up) while the mobile phone 202 is in the operator compartment 216 and the vehicle 214 is moving.

As yet another example, the mobile application 234 may communicate with one or more other mobile applications running on the operating system 236 to determine if another mobile application (e.g., a voice calling application, a text messaging application, an Internet browsing application, etc.) is being used while the mobile phone 202 is in the operator compartment 216 and the vehicle 214 is moving.

In one example implementation, the mobile application 234 may be configured to allow certain use of the mobile phone 202 and/or distinguish between approved use and unapproved use of the mobile phone 202. As one example, use of the GPS 254 of the mobile phone 202 may be allowable while the mobile phone 202 is in the driver compartment 216 and the vehicle 214 is moving.

If a determination if made that the mobile phone 202 is not in use, then use of the mobile phone 202 may not be reported, as shown at block 328, and the method 300 may continue at block 326. Accordingly, when the mobile phone 202 is in the operator compartment 216 and the vehicle 214 is moving but the mobile phone 202 is not is use, an unsafe operating condition may not be created. The operational steps shown at blocks 326, 330, and 342 may be repeated until a determination is made that the mobile phone 202 is in the operator compartment 216, that the vehicle 214 is moving, and that the mobile phone 202 is in use.

If a determination if made that the mobile phone 202 is in use, then use of the mobile phone 202 may be reported, as shown at block 344.

Reporting use of the mobile phone 202 when the mobile phone 202 is in the operator compartment 216 and when the vehicle 214 is moving may be of interest to the operator of the vehicle 214 and/or the third party (e.g., monitoring user).

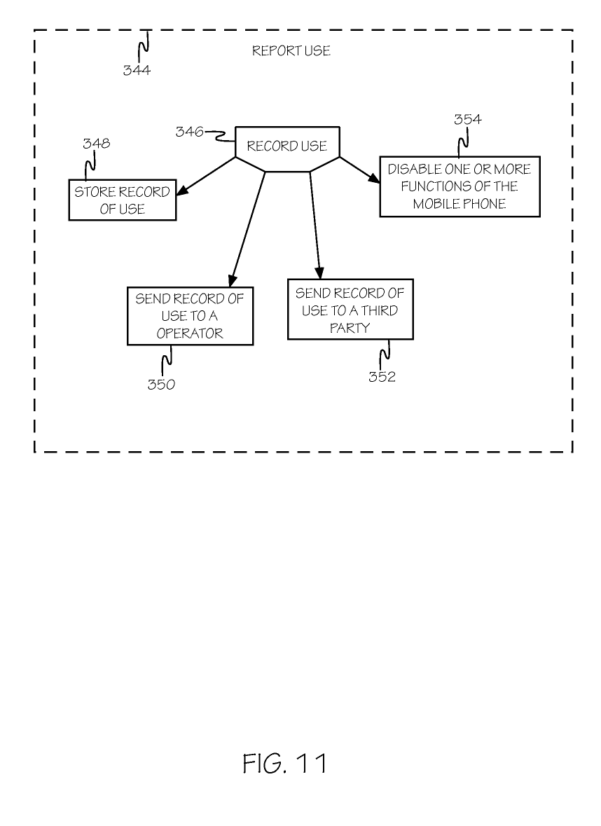

Referring to FIG. 11, and with reference to FIGS. 5-7, in one embodiment, the reporting operation (block 344) may include recording the use of the mobile phone 202 when the mobile phone 202 is in the operator compartment 216 and when the vehicle 214 is moving, as shown at block 346.

In addition to reporting use (block 344) and/or recording use (block 346), the mobile application 234 may record and/or report additional information related to the occurrence of use and/or operation of the vehicle 214. For example, the additional information may include, but is not limited to, the location of the use (e.g., longitude/latitude data), the speed of the vehicle 214, the duration of operation of the vehicle 214 (e.g., drive time), the operating (e.g., driving) conditions (e.g., weather, traffic, etc.), and/or the operating (e.g., driving) pattern to identify operating habits. As one example, mobile application 234 may communicate with the GPS 254 of the mobile phone 202 to determine the location of the use and/or the speed of the vehicle 214. As another example, the mobile application 234 may communicate with another mobile application (e.g., a weather app or a traffic app) to determine the operating conditions. As yet another example, the mobile application 234 may communicate with the accelerometer 256 of the mobile phone 202 to determine the operating pattern (e.g., whether the driving pattern was erratic, included sudden starts and/or stops, etc.).

In one example implementation, the record of use may be stored, as shown at block 348. As one example, the record of use may be stored on the mobile phone 202 (e.g., in the memory 226). The record may be retrieved (e.g., downloaded) from the mobile phone 202 by connecting the mobile phone 202 to the computer 260 (e.g., via the data input/output port 238) or by transmitting the stored record to a computer or another mobile computing and/or communication device, for example, over the network 26.

As another example, the record of use may be stored on the mobile application server 258. The mobile application 234 may transmit the record of use to the mobile application server 258 over the network 26. The record may be stored on the mobile application server 258 for retrieval at a later time. The record may be accessed on the mobile application server 258 (e.g., in the form of a webpage) by the computer 260 (e.g., via the Internet 210).

In another example implementation, the mobile application 234 may transmit (e.g., send) the record of use directly to the mobile phone 202 (e.g., of the operator), as shown at block 350, and/or to another mobile computing and/or communication device (e.g., a mobile phone 202) or computer 260 of the monitoring user, for example, over the network 26, as shown at block 352. As one example, each use of the mobile phone 202 when the mobile phone 202 is in the operator compartment 216 and when the vehicle 214 is moving may be transmitted immediately upon the occurrence of use. As another example, plurality of uses (e.g., batches of recorded uses) of the mobile phone 202 when the mobile phone 202 is in the operator compartment 216 and when the vehicle 214 is moving may be transmitted at predetermined time (e.g., at the end of a trip).

In another example implementation, reporting the record of use may take the form of an immediate notification to the driver of the vehicle 214. For example, the notification may include, but is not limited to, a visual alert (e.g., a banner) displayed on the mobile phone 202, a vibration of the mobile phone 202, and/or an audible alarm (e.g., a sound) transmitted by the mobile phone 202.

In another example implementation, the report of use may take the form of an immediate notification to the third party (e.g., the monitoring user). For example, the notification may include, but is not limited to, an email message, a text message, an automated phone call, an automated voicemail recording, an automated instant message (e.g., via Skype), a visual alert displayed on the mobile computing and/or communication device or computer of the third party, an audible alarm (e.g., a sound) transmitted by the mobile computing and/or communication device or computer of the third party, and/or an automated posting on social media (e.g., Twitter, Facebook, Google+, etc.).

In one example implementation, the mobile application 234 may be configured to disable operation of one or more functions (e.g., one or more components and/or mobile applications) of the mobile phone 202 (e.g., mobile device) upon a determination that the mobile phone 202 is in use while the mobile phone 202 is in the operator (e.g., driver) compartment 216 and the vehicle 214 is moving, as shown at block 354.

As one example, the mobile application 234 may disable a portion of the communication interface 232 to prevent communication over the network 26. As another example, the mobile application 234 may terminate (e.g., close) or prevent from starting (e.g., opening) one or more other mobile applications (e.g., a voice calling application, a text messaging application, an Internet browsing application, etc.). As yet another example, the mobile application 234 may initiate a power OFF (e.g., shut down) of the mobile phone 202.

As one example, disabling one or more functions of the mobile phone 202 may occur automatically, such as in response to a determination that the mobile phone 202 is in use while the mobile phone 202 is in the driver compartment 216 and the vehicle 214 is moving.

As another example, disabling one or more functions of the mobile phone 202 may be initiated by the third party (e.g., the monitoring user), such as in response to a notification that the mobile phone 202 is in use while the mobile phone 202 is in the driver compartment 216 and the vehicle 214 is moving.

Accordingly, the disclosed systems and methods may improve vehicle operation safety for an operator (e.g., driver) of a vehicle as well as for other operators (e.g., drivers) of other vehicles (e.g., on the roadways) by providing an immediate reminder to not use a mobile phone while operating the vehicle. Additionally, the disclosed systems and methods may improve vehicle operation safety by providing information about mobile phone use to a parent or employer of the operator for further action.

Although various embodiments of the disclosed system and method have been shown and described, modifications may occur to those skilled in the art upon reading the specification. The present application includes such modifications and is limited only by the scope of the claims.

What is claimed is:

1. A method implemented by a wireless communication device, said method comprising:
determining whether a short-range wireless communication signal is received by said wireless communication device;
determining whether said wireless communication device is at a first position;
determining whether said wireless communication device is in motion;
reporting use of said wireless communication device when said wireless communication device is at said first position and said wireless communication device is in motion.

2. The method of claim 1 wherein determining whether said wireless communication device is at said first position comprises:
acquiring a value from received signal strength indicator data of said short-range wireless communication signal;
comparing said value to a threshold value; and
determining whether said acquired value is greater than or less than said threshold value.

3. The method of claim 2 wherein determining whether said wireless communication device is at said first position further comprises designating said wireless communication device as being at said first position when said acquired value is greater than said threshold value.

4. The method of claim 2 wherein determining whether said wireless communication device is at said first position further comprises designating said wireless communication device as being at a second position when said acquired value is less than said threshold value.

5. The method of claim 1 wherein:
said wireless communication device comprises a mobile phone; and
said short-range wireless communication signal comprises a Bluetooth low energy signal.

6. A method implemented by a mobile device located within a vehicle, said method comprising:
determining whether a wireless communication signal is received by said mobile device;
determining whether said mobile device is in an operator compartment of said vehicle;
determining whether said vehicle is moving;
determining whether said mobile device is in use; and
reporting said use of said mobile device when said mobile device is in said operator compartment and said vehicle is moving.

7. The method of claim 6 wherein determining whether said mobile device is in said operator compartment of said vehicle comprises:
acquiring a value from received signal strength indicator data of said wireless communication signal;
comparing said value to a threshold value; and
determining whether said acquired value is greater than or less than said threshold value.

8. The method of claim 7 wherein determining whether said mobile device is in said operator compartment of said vehicle further comprises designating said mobile device as being in said operator compartment when said acquired value is greater than said threshold value.

9. The method of claim 7 wherein determining whether said mobile device is in said operator compartment of said vehicle further comprises designating said mobile device as being in a passenger compartment when said acquired value is less than said threshold value.

10. The method of claim 7 further comprises defining said threshold value based on a size of said operator compartment.

11. The method of claim 6 wherein reporting said use of said mobile device when said mobile device is in said operator compartment and said vehicle is moving comprises displaying a notification of said use on said mobile device.

12. The method of claim 6 wherein reporting said use of said mobile device when said mobile device is in said operator compartment and said vehicle is moving comprises sending a notification of said use to at least one of: another mobile device and a computer.

13. The method of claim 6 wherein reporting said use of said mobile device when said mobile device is in said operator compartment and said vehicle is moving comprises storing a record of said use on said mobile device.

14. The method of claim 6 further comprising at least one of disabling at least one function of said mobile device and powering off said mobile device in response to said use of said mobile device when said mobile device is in said operator compartment and said vehicle is moving.

15. The method of claim 7 wherein said mobile device comprises a mobile phone.

16. The method of claim 15 wherein said wireless communication signal comprises a Bluetooth low energy signal.

17. A system comprising:
a positioning device configured to transmit a wireless communication signal; and
a mobile device in wireless communication with said positioning device via said wireless communication signal, said mobile device comprising a processing unit, and a non-transitory computer readable medium storing instructions, wherein executing said instructions by said processing unit causes said mobile device to:
determine whether said wireless communication signal is received by said mobile device;
determine whether said mobile device is at a first position or a second position;
determine whether said mobile device is moving;
determine whether said mobile device is in use; and
report said use of said mobile device when said mobile phone is in said first position and said mobile device is moving.

18. The system of claim 17 wherein:
said positioning device and said mobile device are located in a vehicle,
said first position comprises an operator compartment of said vehicle,
said second position comprises a passenger compartment of said vehicle, and
whether said mobile device is moving is determined by movement of said vehicle.

19. The system of claim 18 wherein executing said instructions by said processing unit causes said mobile device to further:
acquire a value from received signal strength indicator data of said wireless communication signal;
compare said value to a threshold value; and
determine whether said acquired value is greater than or less than said threshold value.

20. The system of claim 19 wherein executing said instructions by said processing unit causes said mobile device to further:
designate said mobile device as being in said operator compartment when said acquired value is greater than said threshold value, and
designating said mobile device as being in said passenger compartment when said acquired value is less than said threshold value.
